(19) United States
(12) Patent Application Publication
(10) Pub. No.: US 2007/0157678 A1
(43) Pub. Date: Jul. 12, 2007

(54) Tension lock for exhibition frames

(76) Inventor: Bian Jianzheng, Changzhou (CN)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/585,387

(22) PCT Filed: Dec. 14, 2004
(86) PCT No.: PCT/CN04/01449

§ 371 Date: Jul. 6, 2006

(30) Foreign Application Priority Data
Jan. 6, 2004 (CN) 200410013855.4

(51) Int. Cl. E05B 15/00

(52) U.S. Cl. 70/1

(57) ABSTRACT

A lock device for exhibit framework has a lock shell (1), a lock plate (2) and an eccentric lock wheel (3). On the lock plate (2) there are two long grooves with different width extending to front end of forming there prongs with different width thereof. The front end of every prong is respectively made into claw (21, 22, 23), with opposite directions other. The rear end of lock is curved into the form of U-shaped half loop (26), which is a plane on the end surface (261). The support structure consists of three respective oblique planes (231, 211, 221) of the three prongs and relative oblique bearing surface (131, 131, 111) in the front of the lock shell (1), furthermore, the stop structure consists of a stop dent (27) of the lock plate (2) and an eccentric cam (332) of the eccentric lock wheel (3).

### CROSS-REFERENCE TO RELATED APPLICATIONS

This application is a nationalization of PCT Application No. PCT/CN2004/001449, filed Dec. 14, 2004, which claims priority to Chinese Patent Application No. 200410013855.4 filed Jan. 6, 2004, the contents of which are incorporated herein by specific reference.

### BACKGROUND OF THE INVENTION

1. Field of the invention

This invention generally relates to a connecting lock, and more particularly to a lock for connecting exhibition stands.

2. Background Art

Exhibition stands used, for example, in expositions and other places, for showing and demonstrating products are typically steady frame ones consisting of beams and columns, which are connected and fixed through connecting locks. Prior Chinese Patents ZL99113438 and ZL99113439 disclosed connecting locks invented by the applicant. FIG. 1 shows the composite structure of the connecting lock. FIGS. 2 and 3 show the shape and structure of a lock plate 2. FIG. 4 shows the shape and structure of a lock shell 1. It can be seen from these figures that the connecting lock comprises lock plate 2, an eccentric lock cam 3 and lock shell 1. lock plate 2 is inserted into lock shell 1. After lock plate 2 has been inserted into lock shell 1, eccentric lock cam 3 is inserted through the bottom of lock shell 1 into an opening 15 that has an arc 151 (see FIG. 4), then through hole 5 on lock plate 2, and finally into hole 53 on lock shell 1. Once fully inserted, eccentric lock cam 3 can be rotated to lock the structure in place.

FIG. 2 shows the shape and structure of lock plate 2 of the connecting lock. As depicted, there are two elongated slots 1001 and 1002 on lock plate 2, each slot 1001 and 1002 being divided into three sections 41, 42 and 43 of different widths so that three plate tongues 1010, 1011, and 1012 of different widths are disposed at the front end 1100 of lock plate 2. The front ends of plate tongues 1010, 1011, and 1012 are bent into hooks 21, 22 and 23, respectively, with a reverse bending direction between adjacent hooks. The back end 1102 of lock plate 2 is bent into a U-shaped half-loop 26 having an end surface 261 in the form of a plane.

When eccentric lock cam 3 is rotated, a big cam 361, which is on eccentric lock cam 3 pushes against end surface 261, forcing lock plate 2 to move toward the back end 1106 of lock shell 1. This forces bevels 231, 232 and 233 on plate tongues 1010, 1011, and 1012, respectively, to move backwards along inclined bearing surfaces 131, 121 and 111. Because of this bevel movement, the three hooks 21, 22, and 23 on the front end 1100 of lock plate 2 expand along reverse directions, causing connecting lock fixed in the beam to be locked inside the column section bar. This results in steady and fixed frame exhibition stands. The movement of lock plate 2 is stopped by a small stop cam 362 located on the front end of eccentric lock cam 3 which presses against a side wall of hole trough 5 on lock plate 2.

The connecting lock described above has very good usability and has been applied widely. However, since eccentric lock cam 3 has two cams—big cam 361 and small cam 362, the difficulty of fabrication is increased. Eliminating small stop cam 362 would cause fabrication to be easier. However, it would be necessary to change the stop structure if small stop cam 362 was eliminated, which would cause technical difficulties.

### SUMMARY OF THE INVENTION

The invention is directed to a new kind of connecting lock aimed at solving the above mentioned technical difficulties, and improving on the conventional connecting lock described in the Background section. Improvements to the lock plate and shape and structure of the eccentric lock cam are disclosed, which simplify the connecting lock structure, reduce cost and facilitate ease of use.

The technology solution for the invention is: a connecting lock used for exhibition stands, comprising a lock shell 1, a lock plate 2 and an eccentric lock cam 3.

The lock shell has inclined bearing surfaces 131, 121 and 111 in a front portion 1104 thereon.

Lock plate 2 has a front end 1100 and a back end 1102, with a plurality of plate tongues 1010, 1011, and 1012 having different widths being disposed at the front end 1100 of lock plate 2. The front end of each plate tongue 1010, 1011, and 1012 are bent into hooks 21, 22, and 23, respectively, with a reverse bending direction between adjacent hooks. Each plate tongue has a beveled surface 231, 211, and 221. The plate tongues are separated by a plurality of elongated slots 1001 and 1002, each slot being divided into three sections 41, 42, and 43 of different widths. The back end 1102 of lock plate 2 is bent into a U-shaped half-loop 26 having an end surface 261 in the form of a plane. A stop tooth 27 is also disposed on lock plate 2.

Eccentric lock cam 3 comprises a fully arc shaped eccentric cam 332, a big shaft 333, and a small shaft 331. A Quincunx hole 334, which allows easy rotation of eccentric lock cam 3 with a special matching tool, is formed on the surface of big shaft 333.

By adopting the above mentioned improvements, the structure of the Plate tongue and Eccentric lock cam is simplified and the stop structure is changed. As a result, the structure and process of the connecting lock is further simplified, the cost is saved, and the adaptability is increased.

### BRIEF DESCRIPTION OF THE DRAWINGS

FIG. 1 is a cross sectional side view showing the composite structure of an existing connecting lock;

FIG. 2 is a side view of the lock plate shown in FIG. 1;

FIG. 3 is a top view of the lock plate shown in FIG. 2;

FIG. 4 is a bottom view of a lock shell according to one embodiment of the invention;

FIG. 5 is a cross sectional side view of the lock shell shown in FIG. 4;

FIG. 6 is a cross sectional side view of a connecting lock according to one embodiment of the invention;

FIG. 7 is a side view of the lock plate shown in FIG. 6;

FIG. 8 is a top view of the lock plate shown in FIG. 7;

FIG. 9 is a partial cross sectional side view of the eccentric lock cam shown in FIG. 6;

FIG. 10 is a left view of the eccentric lock cam shown in FIG. 9;

FIG. 11 is a right view of the eccentric lock cam shown in FIG. 9;

FIG. 12 is a bottom view of a connecting lock according to another embodiment of the invention; and

FIG. 13 is a cross sectional side view of the connecting lock shown in FIG. 12.

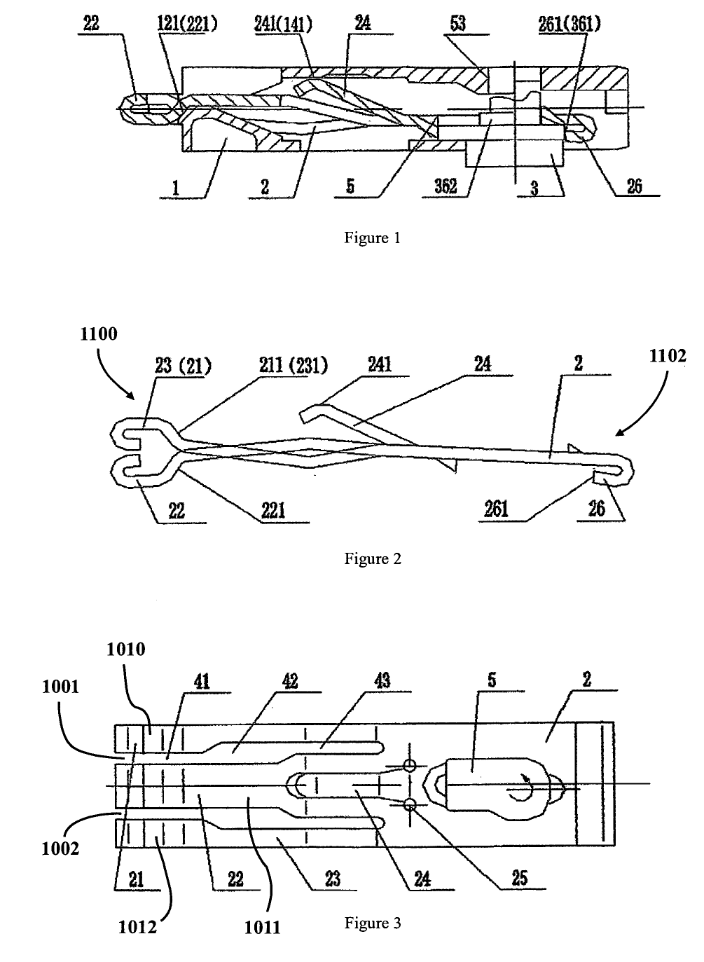

In FIGS. 1-3 an existing technical connecting lock is shown, where:
is the lock plate,
3 is the eccentric lock cam,
1 is the lock shell,
1100 and 1102 are the front end and back end, respectively, of lock plate 2;
1104 and 1106 are the front end and back end, respectively, of lock shell 1;
15 is the opening with an arc 151 formed on lock shell 1,
5 is the hole formed on lock plate 2,
53 is the hole formed on bottom side of lock shell 1,
1001 and 1002 are slots with different widths 41, 42 and 43 formed on lock plate 2,
1010, 1011, and 1012 are plate tongues with different widths disposed on the front end of lock plate 2,
21, 22 and 23 are hooks of plate tongues 1010, 1011, and 1012 respectively;
361 is the big cam on eccentric lock cam 3;
362 is the stop cam on the front end of eccentric lock cam 3;
26 is a U-shaped half loop on the back end of lock plate 2;
24 is the elastic brace rod on lock plate 2;
241 and 141 are the contact points of elastic brace rod 24 on the internal surface of lock shell 1;
221 and 121 are the parts of the braced structure between the hook bevel on the front end of lock plate 2 and the lock shell 1 bearing plane.

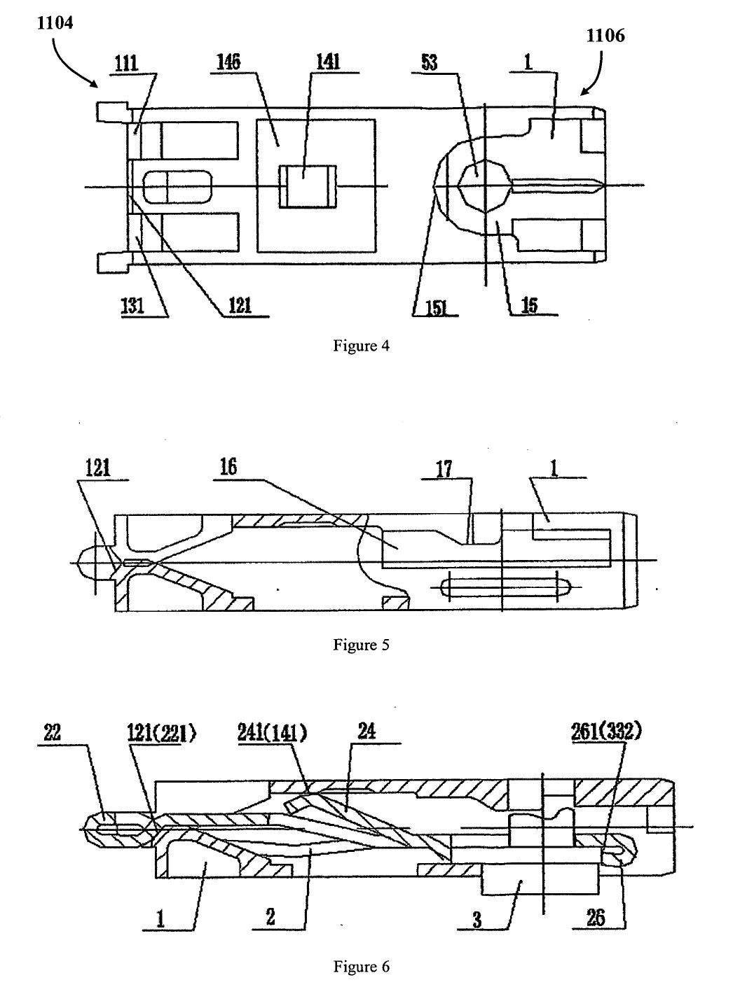

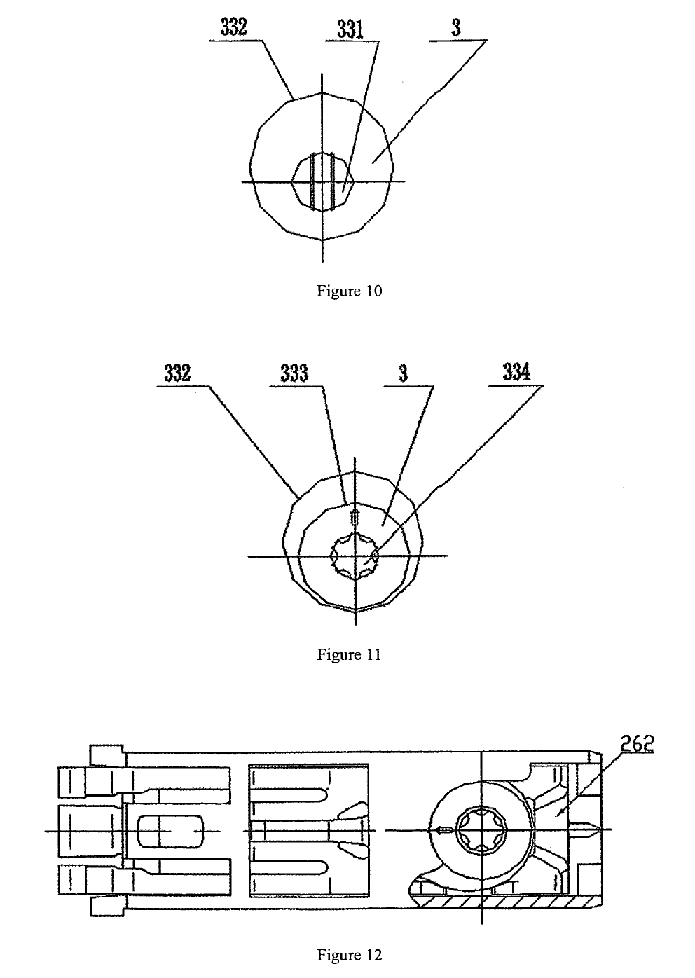

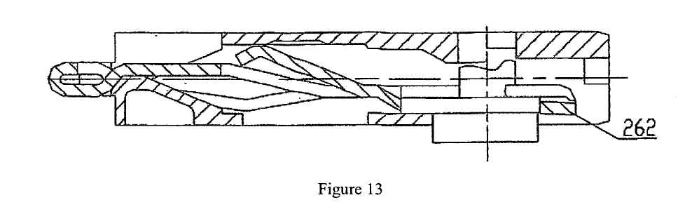

In FIGS. 4-11:
is the lock shell;
is the lock plate;
is the eccentric lock cam;
1100 and 1102 are the front end and back end, respectively, of lock plate 2;
1104 and 1106 are the front end and back end, respectively, of lock shell 1;
1010, 1011, and 1012 are plate tongues with different widths disposed on the front end of lock plate 2,
1001 and 1002 are slots with different widths 41, 42 and 43 formed on lock plate 2,
41, 42 and 43 are sections of elongated slots 1001 and 1002 with different widths;
21, 22 and 23 are hooks bent from the front end of plate tongues 1010, 1011, and 1012 on lock plate 2, where hook 21 and 23 have the same bending direction, while hook 22 has the reverse direction;
211, 221 and 231 are the transition bevels between hooks 21, 22, and 23 and plate tongues 1010, 1011, and 1012;
55 is the hole formed on lock plate 2;
551 is the flange of hole 55 on lock plate 2;
16 is the rectangular hole on the side surfaces of lock shell 1;
17 is the flange strip on the internal surface on the bottom of lock shell 1;
111, 121 and 131 are the inclined bearing surfaces supporting blocks of hook transition bevels 211, 221 and 231;
15 is the opening with an arc 151 formed on the upper surface of lock shell 1, where eccentric lock cam 3 is inserted;
53 is a small hole on the lower side surface of lock shell 1 that matches the small shaft 331 of eccentric lock cam,

146 is the rectangular hole formed on the internal surface of lower side of lock shell 1;
26 is a U-shaped half loop on the back end of lock plate 2 having an end surface in the form of a plane;
124 is the elastic brace rod on lock plate 2,
241 is the contact point between elastic brace rod and 141 on internal surface of lower side of lock shell 1,
27 is the stop tooth on lock plate 2 that, together with eccentric cam 332 constitute the stop structure,
28 is the barrier tooth on lock plate 2,
331 is the small shaft of eccentric lock cam 3, which is inserted into the small hole 53 on the lower side surface of lock shell 1 through hole 55 formed on lock plate 2;
332 is a fully arc shaped eccentric cam located on hole 55 of lock plate 332 that, together with stop tooth 27 constitute the stop structure;
333 is the big shaft at the head of eccentric lock cam 3, matching with the side arc 151 on lock shell 1,
334 is a Quincunx lock hole 334, which is easy for lock and open, formed on the surface of big shaft 333 at the head of eccentric lock cam 3.

### DETAILED DESCRIPTION

As shown in FIGS. 4-11, A connecting lock for exhibition stands comprises a lock shell 1, a lock plate 2 and an eccentric lock cam 3.

Lock shell 1 is designed to receive lock plate 2. Lock shell 1 has inclined bearing surfaces 131, 121 and 111 in a front portion 1104 thereon. Lock shell 1 also forms two holes 15 and 53 that are configured to receive eccentric lock cam 3. Opening 15 has an arc 151. A first rectangular hole 146 is formed on the upper surface of lock shell 1, and a second rectangular hole 16 is formed on the upper side of lock shell 1. A flange strip 17 is disposed on the internal surface of the bottom side of lock shell 1 (See FIGS. 4 and 5).

Lock plate 2 has a front end 1100 and a back end 1102, with a plurality of plate tongues 1010, 1011, and 1012 having different widths being disposed at the front end 1100 of lock plate 2. The front end of each plate tongue 1010, 1011, and 1012 are bent into hooks 21, 22, and 23, respectively, with a reverse bending direction between adjacent hooks. Each plate tongue has a beveled surface 231, 211, and 221. The plate tongues are separated by elongated slots 1001 and 1002, with each slot being divided into three sections 41, 42, and 43 of different widths. The back end 1102 of lock plate 2 is bent into a U-shaped half-loop 26 having an end surface 261 in the form of a plane. A stop tooth 27 is also disposed on lock plate 2.

Eccentric lock cam 3 comprises a fully arc shaped eccentric cam 332, a big shaft 333, and a small shaft 331. A Quincunx hole 334, which allows easy rotation of eccentric lock cam 3 with a special matching tool, is formed on the surface of big shaft 333. (See FIGS. 9-11)

Stop tooth 27 on lock plate 2 and arc shaped eccentric cam 332 on eccentric lock cam 3 combine to constitute a stop structure for the connecting lock.

During use, lock plate 2 is inserted into lock shell 1. After lock plate 2 has been inserted into lock shell 1, eccentric lock cam 3 is first inserted through the bottom of lock shell 1 into opening 15 on lock shell 1. After passing through opening 15, eccentric lock cam 3 is inserted through hole 55 on lock plate 2 and into hole 53 of lock shell 1.

After eccentric lock cam 3 has been fully inserted through opening 15 and holes 55 and 53, eccentric lock 3 is rotated counterclockwise with a special tool until eccentric lock cam 3 reaches stop tooth 27, which prevents eccentric lock cam 3 from rotating anymore (see FIGS. 4, 5, 6, 7, 8, 9, 10 and 11). Whereas lock plate 2 relies on an acting force generated by eccentric lock cam 3 to realize back and forth movement, the setting of a working point is better for eccentric lock cam 3 to be able to apply the acting force on lock plate 2. In one embodiment, the working point is formed by bending the back end 1102 of lock plate 2 into a U-shaped half-loop 26 having an end surface 261 which is a plane. When lock plate 2 is inserted into lock shell 1, eccentric cam 332 pushes against the end surface 261 of half-loop 26 at the back end 1102 of lock plate 2. This moves lock plate 2 backwards, causing bevels 231, 211 and 221 on plate tongues 1010, 1011, and 1012 to move backwards along inclined bearing surfaces 131, 121 and 111 in the front end of lock shell 1. This causes hooks 21, 22 and 23 on the front end of lock plate 2 to expand along reverse directions, causing the connecting lock fixed in the beam to be locked inside the column section bar, forming steady and fixed frame exhibition stands.

Other technical measures can also be used to realize the back and forth movement. For example, in one embodiment, a wedged bulge 262 is disposed on the back end 1102 of lock plate 2 such that bulge 262 is disposed behind eccentric lock cam 3 when eccentric lock cam 3 is inserted into the connecting lock. This can constitute a “V” shape through connecting with lock plate 2. The fabrication of wedged bulge 262 can be completed during the manufacturing process of lock plate 2 together with the punch of lock plate 2. Compared with the process of bending edge folds to get the working point of the acting force, this is a much simpler process. The manufacturing process of wedged bulge 262 may be realized along with the punch process of lock plate 2 manufacturing, so it has the advantages of lower manufacturing costs due to the simple process. The “V” shaped connection between wedged bulge 262 and lock plate 2 applied in this technical measure will also increase the connecting strength between wedged bulge 262 and lock plate 2, enabling wedged bulge 262 to have a better bearing capability. Also, because this technical measure can make the contact surface between eccentric lock cam 3 and lock plate 2 to be vertical with the direction of the acting force that pushes lock plate 2, the reliability of this invention is enhanced.

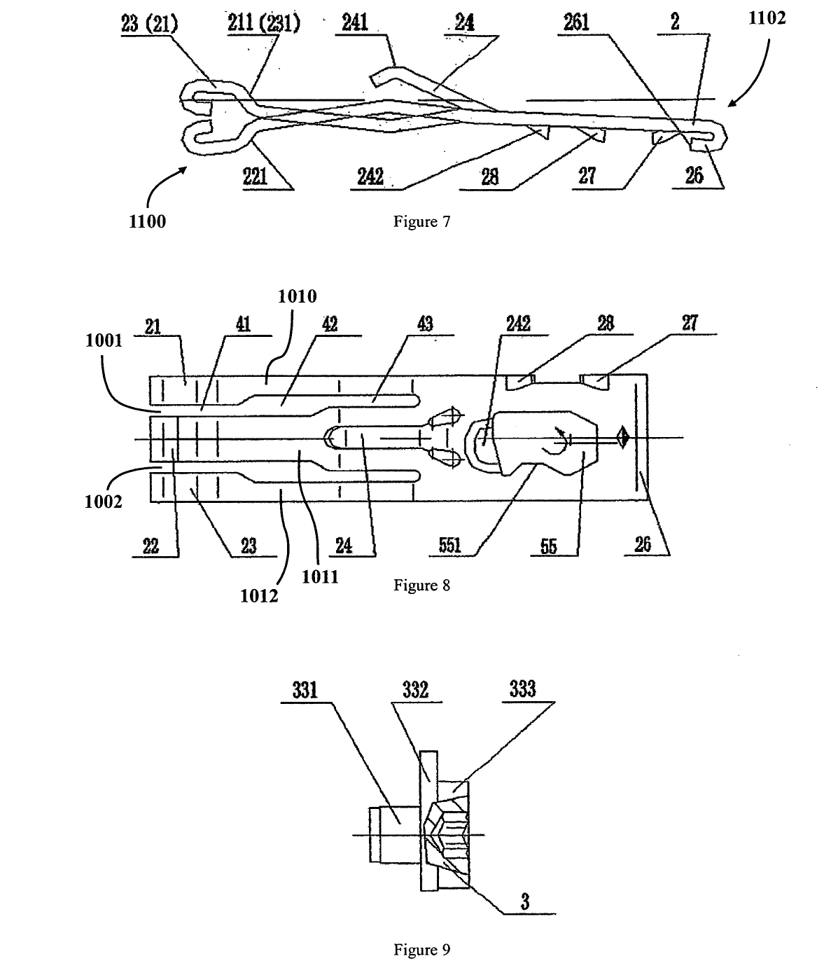

A barrier tooth 28 can also be disposed on lock plate 2 to restrict eccentric cam 332 from rotating clockwise. Hole 55 on Lock plate 2 also has a flange 551 (see FIGS. 7 and 8).

1-8. (canceled)

9. A connecting lock for exhibition stands, the connecting lock comprising:
a lock shell having inclined bearing surfaces in a front portion thereon;
a lock plate having a front end and a back end, a plurality of plate tongues being disposed at the front end of the lock plate, an end of each plate tongue being bent into a hook with a reverse bending direction between adjacent hooks and each plate tongue having a beveled surface, the plate tongues being separated by a plurality of elongated slots, each slot being divided into three sections of different widths;
a stop tooth disposed on the lock plate; and
an eccentric lock cam, having an eccentric cam, the lock plate being inserted into the lock shell, and the eccentric lock cam being inserted through a first hole and a second hole, and into a third hole, wherein the first hole has an arc and the first hole and the third hole are formed in the lock shell, and the second hole is formed in the lock plate,
wherein the eccentric cam on the eccentric lock cam and the stop tooth on the lock plate constitute a stop structure.

10. The connecting lock as defined in claim 9, further comprising a barrier tooth on the lock plate.

11. The connecting lock as defined in claim 9, wherein a first rectangular hole is formed on an upper surface of the lock shell.

12. The connecting lock as defined in claim 9, wherein a second rectangular hole is formed on an upper side of the lock shell.

13. The connecting lock as defined in claim 9, further comprising a flange strip disposed on an internal surface of a bottom side of the lock shell.

14. The connecting lock as defined in claim 9, further comprising a flange on the hole of the lock plate.

15. The connecting lock as defined in claim 9, wherein the back end of the lock plate is bent into a U-shaped half-loop having an end surface that is a planar.

16. The connecting lock as defined in claim 9, further comprising a wedged bulge disposed on the lock plate.
